(19) United States
(12) Patent Application Publication
(10) Pub. No.: US 2008/0174597 A1
(43) Pub. Date: Jul. 24, 2008

(54) Display Control Apparatus, Display Control Method, and Program

(76) Inventor: Tatsuya Takagi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/014,365

(22) Filed: Jan. 15, 2008

(30) Foreign Application Priority Data
Jan. 19, 2007 (JP) P2007-010740

(51) Int. Cl. G06F 17/00

(52) U.S. Cl. 345/418

(57) ABSTRACT

In the present invention, there is provided a display control apparatus for providing a tabular display of a plurality of images divided into a plurality of continuous pages, the display control apparatus including: selection means for selecting from the plurality of images the images to be displayed on each of the plurality of pages; and display control means for controlling the display of the plurality of images in such a manner that the images selected by the selection means are displayed in tabular form on a given page along with parts of the images included in at least either the preceding or the following page continuous to the given page.

### CROSS REFERENCES TO RELATED APPLICATIONS

The present invention contains subject matter related to Japanese Patent Application JP 2007-010740 filed with the Japan Patent Office on Jan. 19, 2007, the entire contents of which being incorporated herein by reference.

### BACKGROUND OF THE INVENTION

1. Field of the Invention

The present invention relates to a display control apparatus, a display control method, and a program. More particularly, the invention relates to a display control apparatus, a display control method, and a program for presenting the user with the display in tabular form of a plurality of images on a plurality of pages in such a manner that the sequence of the pages will be easily known to the user.

2. Description of the Related Art

At present, there exist image editing apparatuses capable of editing and displaying images taken by an imaging device. One such apparatus is disclosed in Japanese Patent Laid-open No. 2006-180074. Some of these apparatuses have a capability to give a tabular view of thumbnails representative of display-ready images so that the user can easily select the preferred images to be displayed.

Some display apparatuses are capable of scrolling a tabular display of thumbnails whenever all thumbnails are not included in a single display screen.

In such a case, the display screen shows a portion of the entire table of thumbnails. By operating the display apparatus, typically by clicking on scroll bars on the display screen, the user may scroll the thumbnail table to call up the thumbnails not included in the current screen for verification purposes.

However, because the scroll display generally needs carrying out image processing involving large quantities of data to be dealt with, this method is not suitable for apparatuses with limited rendering capabilities. In other words, the low-performance apparatuses are incapable of scrolling the thumbnail table as quickly as desired.

Meanwhile, there is a method whereby a tabular view of thumbnails is divided into a plurality of pages so that the thumbnails may be displayed quickly one page at a time even by display apparatuses of limited processing capabilities. Where thumbnails are divided into a plurality of continuous pages for tabular display, the user may operate the display apparatus to call up the preceding or the following page from the currently displayed page in order to verify the thumbnails found on the newly displayed page.

For example, each page may be arranged to accommodate up to 12 thumbnails in columns and rows of three by four in tabular form; any thumbnails exceeding the 12-thumbnail-per-page format may be shown on the second and subsequent pages. In this case, each displayed page may bear symbols such as arrows indicating the presence of the preceding or the next page. These symbols should allow the user to know that there exists the preceding and/or the next page of thumbnails that may be called up.

### SUMMARY OF THE INVENTION

However, when the method for displaying thumbnails in a plurality of pages for display in tabular form is in place, novice users not familiar with user interfaces regarding the tabular display of thumbnails are typically unable to understand what these symbols on the pages mean; such users often have difficulty in knowing the presence of the preceding or the following page of more thumbnails.

The present invention has been made in view of the above circumstances and provides arrangements such that when a plurality of images are divided into a plurality of pages for display in tabular form, the user can easily become aware that there is the preceding or the following page of images that may be displayed.

In carrying out the present invention and according to one embodiment thereof, there is provided a display control apparatus for providing a tabular display of a plurality of images divided into a plurality of continuous pages, the display control apparatus including: selection means for selecting from the plurality of images the images to be displayed on each of the plurality of pages; and display control means for controlling the display of the plurality of images in such a manner that the images selected by the selection means are displayed in tabular form on a given page along with parts of the images included in at least either the preceding or the following page continuous to the given page.

Preferably, the display control means may cause the selected images for display in tabular form on the given page to be arranged in a first direction as well as in a second direction different from the first direction, the parts of the included images being arrayed in a manner parallel with the first direction and continuous to the given page in the second direction.

Preferably, the display control means may further display a cursor for selecting one of the images for display in tabular form on the given page, the display control means further renders the images on the given page starting from the image being selected by the cursor.

Preferably, if an instruction is given to move the cursor before the rendering of the images on the given page is completed, then the display control means may render the yet-to-be rendered images successively starting from the image selected anew by the moved cursor.

Preferably, if an instruction is given to display the images on the given page in a first display format different from a second display format in which the images on the given page are currently displayed in tabular form, then the display control means may display the images in the first display format in such a manner that the image selected by the cursor on the given page in the second display format is also selected by the cursor in the first display format.

Preferably, the display control means may control the display of the plurality of images in such a manner as to start rendering a portion of the given page other than the selected images for display in tabular form and the parts of the included images on the given page, so that the rendering of the selected images for display in tabular form and of the parts of the included images on the given page is started upon completion of the rendering of the portion.

Preferably, the display control means may render successively the selected images for display in tabular form on the given page starting from the image of utmost priority.

According to another embodiment of the present invention, there is provided a display control method for providing a tabular display of a plurality of images divided into a plurality of continuous pages, as well as a program for causing a computer to carry out a display control process equivalent to the display control method, the method including the steps of: selecting from the plurality of images the images to be displayed on each of the plurality of pages; and controlling the display of the plurality of images in such a manner that the selected images are displayed in tabular form on a given page along with parts of the images included in at least either the preceding or the following page continuous to the given page.

As outlined above, the display control apparatus embodying the present invention provides a tabular display of a plurality of images divided into a plurality of continuous pages. The inventive apparatus includes the selection means for selecting from the plurality of images the images to be displayed on each of the plurality of pages. The apparatus also includes the display control means for controlling the display of the plurality of images in such a manner that the images selected by the selection means are displayed in tabular form on a given page along with parts of the images included in at least either the preceding or the following page continuous to the given page.

The embodiment above of the present invention thus provides tabular display of a plurality of images. In particular, when displaying multiple images in tabular form on a plurality of pages, the embodiment enables the user to know easily and reliably whether there exist the preceding and the following pages continuous to the currently displayed page of images.

### BRIEF DESCRIPTION OF THE DRAWINGS

FIG. 1 is a block diagram showing a typical structure of a display apparatus embodying the present invention;

FIG. 2 is a schematic view showing how thumbnails are typically displayed in tabular form in columns and rows;

FIG. 3 is another schematic view showing how thumbnails are displayed in tabular form in columns and rows;

FIG. 4 is a schematic view showing how thumbnails are typically displayed in tabular form in a single column;

FIG. 5 is a flowchart of steps constituting a tabular display process; and

FIG. 6 is a block diagram showing a typical structure of a personal computer.

### DETAILED DESCRIPTION OF THE PREFERRED EMBODIMENTS

What is described below as the preferred embodiments of the present invention with reference to the accompanying drawings corresponds to the appended claims as follows: the description of the preferred embodiments basically provides specific examples supporting what is claimed. If any example of the invention described below as a preferred embodiment does not have an exactly corresponding claim, this does not mean that the example in question has no relevance to the claims. Conversely, if any example of the invention depicted hereunder has a specifically corresponding claim, this does not mean that the example in question is limited to that claim or has no relevance to other claims.

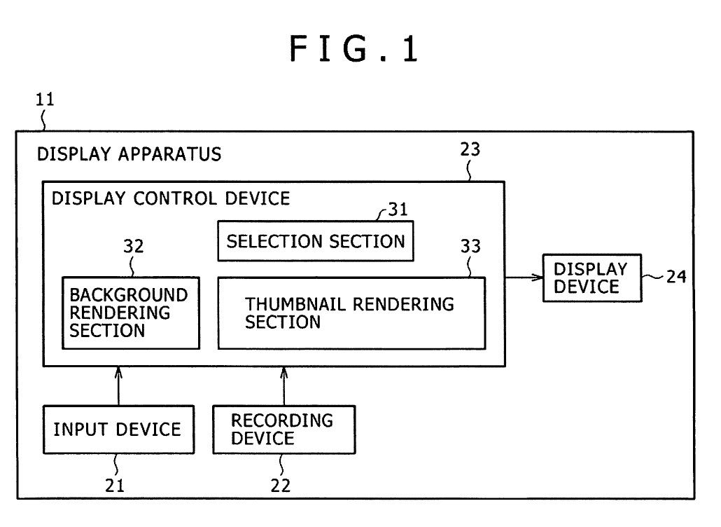

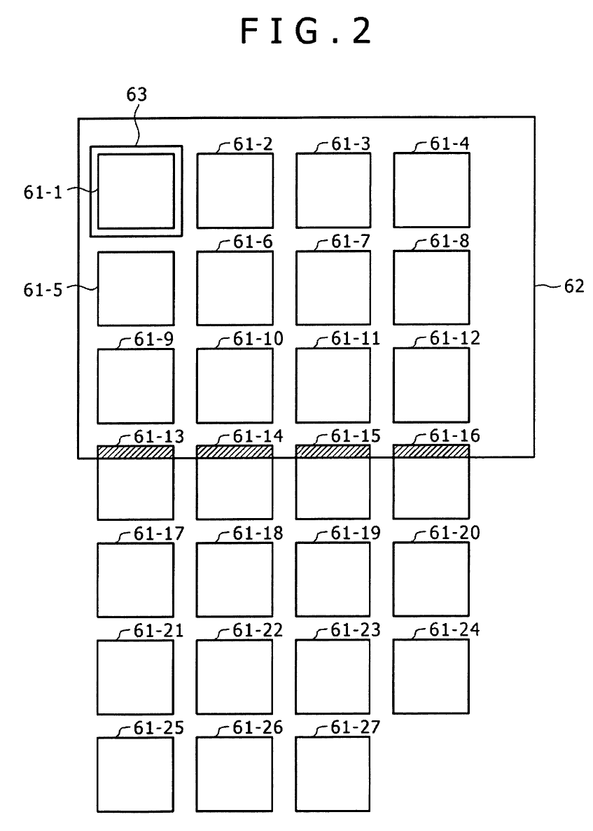

One embodiment of the present invention is a display control apparatus for providing a tabular display of a plurality of images divided into a plurality of continuous pages, the display control apparatus including: selection means (e.g., selection section 31 in FIG. 1) for selecting from the plurality of images the images to be displayed on each of the plurality of pages; and display control means (e.g., background rendering section 32 and thumbnail rendering section 33 in FIG. 1) for controlling the display of the plurality of images in such a manner that the images selected by the selection means (e.g., thumbnails 61-1 through 61-12 in FIG. 2) are displayed in tabular form on a given page along with parts of the images (e.g., parts of thumbnails 61-13 through 61-16 in FIG. 2) included in at least either the preceding or the following page continuous to the given page.

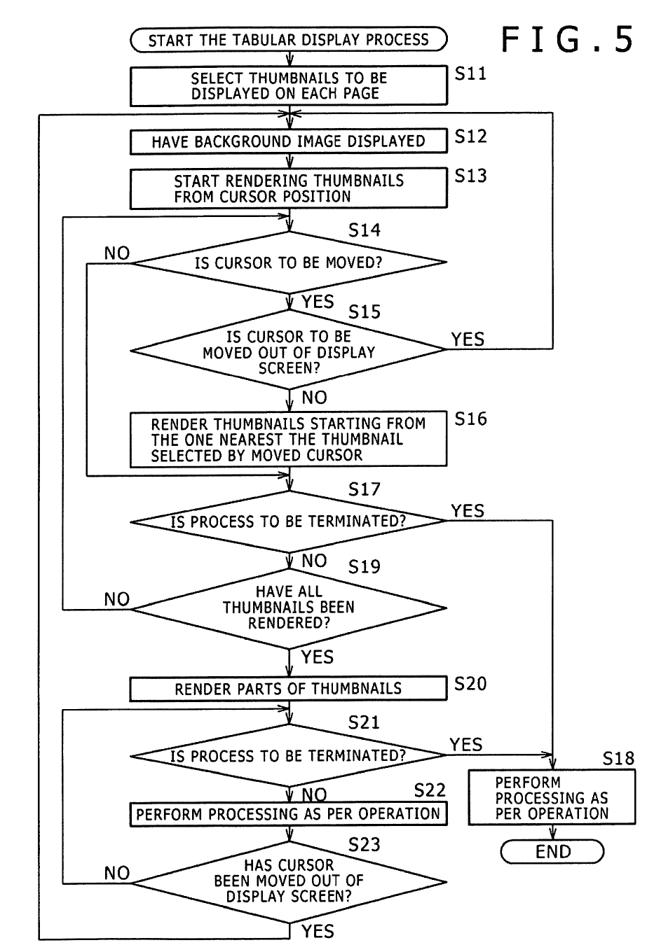

Preferably, the display control means may cause the selected images for display in tabular form on the given page to be arranged in a first direction (e.g., horizontal direction FIG. 2) as well as in a second direction (e.g., vertical direction in FIG. 2) different from the first direction, the parts of the included images being arrayed in a manner parallel with the first direction and continuous to the given page in the second direction (e.g., in steps S13 through S20 of FIG. 5).

Preferably, the display control means may further display a cursor (e.g., cursor 63 in FIG. 2) for selecting one of the images for display in tabular form on the given page, the display control means further renders the images on the given page starting from the image being selected by the cursor (e.g., in step S13 of FIG. 5).

Preferably, if an instruction is given to move the cursor before the rendering of the images on the given page is completed, then the display control means may render the yet-to-be rendered images successively starting from the image selected anew by the moved cursor (e.g., in step S16 of FIG. 5).

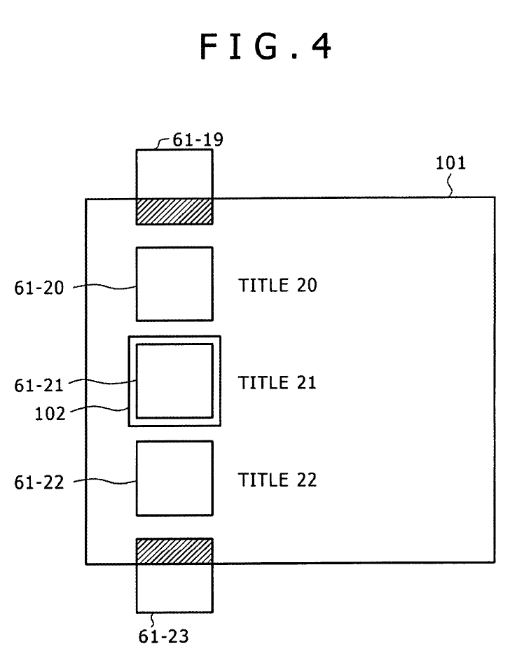

Preferably, if an instruction is given to display the images on the given page in a first display format (e.g., column-and-row display format in FIG. 2) different from a second display format (e.g., single-column display format in FIG. 4) in which the images on the given page are currently displayed in tabular form, then the display control means may display the images in the first display format in such a manner that the image selected by the cursor on the given page in the second display format is also selected by the cursor in the first display format (e.g., in steps S12 and S13 of FIG. 5).

Preferably, the display control means may control the display of the plurality of images in such a manner as to start rendering a portion of the given page other than the selected images for display in tabular form and the parts of the included images on the given page, so that the rendering of the selected images for display in tabular form and of the parts of the included images on the given page is started upon completion of the rendering of the portion (e.g., in steps S12 and S13 of FIG. 5).

Another embodiment of the present invention is a display control method for providing a tabular display of a plurality of images divided into a plurality of continuous pages, as well as a program for causing a computer to carry out a display control process equivalent to the display control method, the method including the steps of: selecting (e.g., in step S11 of FIG. 5) from the plurality of images the images to be displayed on each of the plurality of pages; and controlling (e.g., in steps S12 and S20 of FIG. 5) the display of the plurality of images in such a manner that the selected images are displayed in tabular form on a given page along with parts of the images included in at least either the preceding or the following page continuous to the given page.

The preferred embodiments of the present invention will now be described in reference to the accompanying drawings.

FIG. 1 is a block diagram showing a typical structure of a display apparatus 11 embodying the present invention.

The display apparatus 11 is typically a TV set, a personal computer, or a digital still camera and displays thumbnails in tabular form in increments of pages. The display apparatus 11 may be constituted by an input device 21, a recording device 22, a display control device 23, and a display device 24.

The input device 21 is illustratively made up of buttons and a remote commander, and supplies the display control device 23 with an input signal reflecting the user's operations on the input device 21. The recording device 22 is typically made up of a hard disk drive and/or removable media such as an optical disk and a semiconductor memory that may be attached and removed to and from the display apparatus 11. The hard disk drive is typically incorporated in the display apparatus 11. As such, the recording device 22 stores contents including moving and still images as well as thumbnails representative of these contents.

The display control device 23 acquires contents from the recording device 22 in response to the input signal coming from the input device 21 and supplies the acquired content to the display device 24 for display purposes. Furthermore, the display control device 23 obtains thumbnails from the recording device 22 and feeds the retrieved thumbnails to the display device 24 for display in tabular form.

The display control device 23 is furnished with a selection section 31, a background rendering section 32, and a thumbnail rendering section 33. Where thumbnails retrieved from the recording device 22 are to be displayed in tabular form over a plurality of pages on the display device 24, the selection section 31 of the display control device 23 selects the thumbnails to be displayed on each page.

The background rendering section 32 controls the display device 24 to render a background image against which thumbnails are to be displayed in tabular form on the display device 24. The background image may include a background landscape, a cursor for selecting a thumbnail, titles of the thumbnails being displayed, a frame enclosing a thumbnail display area, and anything other than the thumbnails (as well as parts of thumbnails, to be more precise) displayed on the currently appearing page. The thumbnail rendering section 33 causes the display device 24 to render the thumbnails to be displayed in tabular form on the device 24.

The display device 24 is typically a liquid crystal display (LCD) or like equipment. Under control of the display control device 23, the display device 24 displays contents or thumbnails in tabular form.

Suppose that the user operates the input device 21 to designate one of the folders recorded on the recording device 22 and to give an instruction to display the thumbnails from the designated folder in tabular form. In that case, the selection section 31 of the display control device 23 selects the thumbnails to be displayed in tabular form on each page in accordance with the input signal supplied by the input device 21 in a manner reflecting the user's operations.

Illustratively, it is assumed here that as shown in FIG. 2, a user-designated folder contains a total of 27 thumbnails 61-1 through 61-27 and that each page displays in tabular form four thumbnails per row and three per column.

It is also assumed that each of the thumbnails 61-1 through 61-27 is representative of a still image taken illustratively by a digital still camera, a still image acquired from an external apparatus, or a scene of a moving image acquired externally. The thumbnails 61-1 through 61-27 may be generically referred to as the thumbnail or thumbnails 61 if there is no need to distinguish between the individual thumbnails.

The selection section 31 selects a predetermined number of thumbnails to be displayed in tabular form on each page in a predetermined sequence such as the chronological order in which the still images, represented by the thumbnails 61, were taken. For example, if it is decided beforehand that 12 thumbnails 61 are to be displayed per page, then the selection section 31 selects the first 12 thumbnails in the predetermined sequence for display in tabular form on the first page, and then chooses the next 12 thumbnails also for tabular display on the next page.

In FIG. 2, the thumbnails 61-1 through 61-27 are arrayed from left to right, four thumbnails per row, in ascending order of their reference numerals. Four thumbnails constitute each of the three rows that are arranged in parallel with one another in the vertical direction.

As shown in FIG. 2, the selection section 31 selects the first three rows of thumbnails 61-1 through 61-12 for display in tabular form on page 1. The selection section 31 proceeds to select the next tree rows of thumbnails 61-13 through 61-24 also for tabular display on page 2 continued from the bottom row of thumbnails 61 on page 1. The selection section 31 then selects the thumbnails 61-25 through 61-27 for display in tabular form on page 3.

When the thumbnails 61 are displayed in tabular form on page 1, the display screen of the display device 24 gives tabular display of the thumbnails 61, enclosed by a rectangular frame 62, on the first page. On page 1, the display screen also displays parts of the thumbnails 61-13 through 61-16 making up the top row on page 2 continued from the bottom row of thumbnails on the first page.

In FIG. 2, those parts of the thumbnails 61-13 through 61-16 which are arrayed horizontally are shown vertically continuous to the thumbnails 61-9 through 61-12 in the bottom row of page 1. In FIG. 2, those parts of the thumbnails 61-13 through 61-16 which appear included in the tabular display of page 1 are shown shaded by diagonal lines.

The tabular display of the thumbnails 61 includes a cursor 63 for selecting one of the thumbnails. By operating the input device 21, the user can move the cursor 63 across the display screen showing the thumbnails. Suitably operating the input device 21 allows the user to reproduce the still or moving image represented by the cursor-selected thumbnail 61.

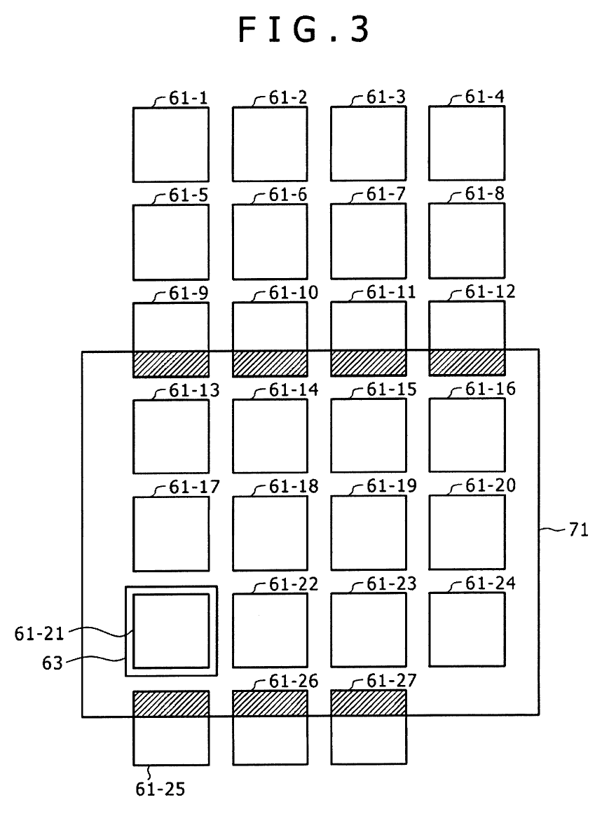

The user may then operate the input device 21 to move the cursor 63 outside of page 1 currently displaying the thumbnails 61 in tabular form or to designate display of the next page of thumbnails 61 away from the current page on the display device 24. In this case, the display screen of the display device 24 shows the thumbnails 61 of page 2 displayed in tabular form, enclosed by a rectangular frame 71 as shown in FIG. 3. Those parts in FIG. 3 which have their counterparts shown included in FIG. 2 are designated by like reference numerals and their descriptions are omitted.

Suppose now that with the thumbnail 61-9 selected among the thumbnails on page 1, i.e., with the cursor 63 focusing on the thumbnail 61-9, the user operates the input device 21 to move the cursor 63 downward so as to select the thumbnail 61-13 from among the thumbnails 61 displayed in tabular form on page 2. In such a case, the display screen of the display device 24 shows the thumbnails 61 of page 2 displayed in tabular form enclosed by the rectangular frame 71.

Page 2 that shows the thumbnails 61 in tabular form in FIG. 3 further displays additional parts of thumbnails: parts of the thumbnails 61-9 through 61-12 which precede the top row of the thumbnails selected for tabular display on page 2 enclosed by the frame 71 and which belong to the last row of the preceding page; and parts of the thumbnails 61-25 through 61-27 which follow the bottom row of the thumbnails 61 selected for page 2 and which belong to page 3.

The parts of the thumbnails 61-9 through 61-12 are shown arrayed from left to right in the row continuous to and in parallel with the top row of thumbnails 61 on page 2; the parts of the thumbnails 61-25 through 61-27 are shown arranged also from left to right in the row continuous to and in parallel with the bottom row of thumbnails on page 2. In FIG. 3, those thumbnail parts shown included on page 2 are shaded by diagonal lines.

Where thumbnails 61 are displayed in tabular form on a page-by-page basis and where the currently displayed page is preceded by another page, parts of the thumbnails 61 in the bottom row of thumbnails on the preceding page are displayed on the display device 24. If the current page is immediately followed by another page, then parts of the thumbnails 61 in the top row of the following page are shown included in the current page on the display device 24.

As described above, each page displays its assigned thumbnails 61 in tabular form, as well as parts of the thumbnails belonging to the immediately preceding and/or the immediately following page. This enables the user to recognize easily and reliably that the current page with its thumbnails 61 displayed in tabular form is preceded and/or followed by another page of thumbnails 61.

Where parts of the thumbnails 61 belonging to the preceding and following pages are included the current page, it is possible to restore the continuity between thumbnails which tend to appear independent when displayed in increments of pages. That is, the thumbnails displayed in tabular form over a plurality of pages make up a single consistent body of thumbnails in the first place. When displayed separately on each page in tabular form, these thumbnails often fail to appear that they actually continue from one page to another; they seem to belong independently to each page from the user's point of view.

When the thumbnails 61 of each page are displayed in tabular form together with parts of the thumbnails 61 belonging to the preceding or the following page where necessary as shown in FIGS. 2 and 3, the user is prompted to become aware that the current page is indeed continuous with the other pages. The user is thus led to recognize that all thumbnails 61 displayed in tabular form over a plurality of pages in fact constitute a single consistent body of thumbnails.

In the description that follows, the parts of thumbnails shown included in the current page that displays thumbnails in tabular form, e.g., the shaded parts of the thumbnails 61-9 through 61-12 as well as the shaded parts of the thumbnails 61-25 through 27, shown enclosed by the frame 71 in FIG. 3, may be simply referred to as the parts of thumbnails 61 where appropriate.

Although FIGS. 2 and 3 show the parts of thumbnails 61 arrayed horizontally and in a manner continuous to the top and/or the bottom row of the thumbnails 61 displayed in tabular form on the current page, this is not limitative of the embodiment according to the present invention. Alternatively, the parts of thumbnails 61 in FIGS. 2 and 3 may be arrayed vertically and in a manner continuous to the leftmost and/or the rightmost column of the thumbnails 61 displayed in tabular form on the current page. For example, suppose that the thumbnails 61-1 through 61-3 and 61-5 through 61-7 in FIG. 3 are displayed in tabular form on page 1 and that the thumbnails 61-4 and 61-8 are displayed also in tabular form on page 2. If that is the case, then parts of the thumbnails 61-4 and 61-8 are displayed in a manner continuous to the rightmost column of the thumbnails 61-3 and 61-7 on page 1.

In another example, with the thumbnails 61 displayed in tabular form enclosed by the frame 71 in FIG. 3, the user may operate the input device 21 to have the thumbnails 61 displayed in a manner different from the thumbnails 61 being currently displayed in tabular form on the display device 24.

Whereas in FIG. 3 the thumbnails 61 are shown arrayed in the vertical and horizontal directions, i.e., in a column-and-row display format, the user may choose to get the thumbnails 61 displayed in the vertical direction or in a single-column display format as illustrated in FIG. 4. Those parts in FIG. 4 which have their counterparts shown included in FIG. 3 are designated by like reference numerals and their descriptions are omitted.

In FIG. 4, the thumbnails 61-19 through 61-23 are arranged from top to bottom in ascending order of their reference numerals in a single column. These thumbnails 61 are displayed in tabular form on a given page enclosed by a rectangular frame 101.

On the page encompassed by the frame 101 appear three thumbnails 61-20 through 61-22 from the top down in ascending order of their reference numerals. On the right-hand side of the thumbnails 61-20 through 61-22 are characters “Title 20,” “Title 21” and “Title 22” constituting the titles of the still pictures represented by these thumbnails respectively.

Also on the page enclosed by the frame 101 is a cursor 102 for selecting a thumbnail 61. By operating the input device 21, the user can move the cursor 102 across the tabular display of the thumbnails 61.

Furthermore, the page encompassed by the frame 101 displays parts of thumbnails 61: a part of the thumbnail 61-19 displayed at the bottom of the thumbnail column in tabular form on the page preceding the current page; and a part of the thumbnail 61-23 displayed at the top of the thumbnail column in tabular form on the page immediately following the current page. These parts of thumbnails 61 included on the current page in FIG. 4 are shown shaded by diagonal lines.

With the thumbnail 61-22 selected by the cursor 102, the user may illustratively operate the input device 21 to move the cursor downward in order to select the thumbnail 61-23 anew. In that case, the display device 24 displays the page next to the current page shown enclosed by the frame 101, the new page showing the thumbnails 61-23 through 61-25 arranged in the vertical direction in tabular form.

The newly displayed page also shows a part of the thumbnail 61-22 from the preceding page and a part of the thumbnail 61-26 from the following page in addition to the thumbnails 61-23 through 61-25.

In the ensuing description, the format in which the thumbnails 61 are displayed vertically in a single column in tabular form as shown in FIG. 4 will be referred to as the single-column display format. By suitably operating the input device 21, the user may switch from the single-column display format of thumbnails to the column-and-row display format in tabular form on the display device 24. Conversely, the user may operate the input device 21 to switch from the column-and-row display format of thumbnails to the single-column display format in tabular form on the display device 24. In either case, the thumbnails to be displayed in tabular form remain the same.

Described below in reference to the flowchart of FIG. 5 is a tabular display process by which the display apparatus 11 displays thumbnails in the column-and-row display format in tabular form. This process is started when the user, suitably operating the input device 21, gives an instruction to display thumbnails in the column-and-row display format.

In step S11 of FIG. 5, the selection section 31 selects the thumbnails to be displayed in tabular form on each of a plurality of pages.

Illustratively, the user may operate the input device 21 to designate a desired folder from which to retrieve thumbnails for display in tabular form. The user's operations cause the input device 21 to supply an input signal to the selection section 31. In response, the selection section 31 selects from the recording device 22 the thumbnails stored in the folder designated by the user.

Given the selected thumbnails, the selection section 31 assigns a predetermined number of thumbnails to each page in a predetermined sequence, such as in the chronological order in which the still images represented by the thumbnails in question were taken, or in a desired sequence in which the scenes designated by the thumbnails are to be reproduced.

More specifically, when the thumbnails 61 targeted for tabular display are arrayed in a predetermined sequence as shown in FIG. 2, the selection section 31 may select a predetermined number of rows of continuously arranged thumbnails 61 for display on each page in tabular form.

For example, as indicated in FIG. 2, the selection section 31 may select the first three consecutive rows of thumbnails 61-1 through 61-12 for display in tabular form on page 1. The top row is formed by the thumbnails 61-1 through 61-4, the second row by the thumbnails 61-5 through 61-8, and the third row by the thumbnails 61-9 through 61-12.

The selection section 31 may then select the next three consecutive rows, i.e., the fourth through the sixth rows of thumbnails 61-13 through 61-24 for display in tabular form on the next page (page 2). The selection section 31 proceeds to select likewise the predetermined number of rows of thumbnails 61 continuously on a page-by-page basis.

As another example, with the thumbnails 61 displayed in the single-column display format in tabular form on the display device 24 as shown in FIG. 4, the user may operate the input device 21 to give an instruction to have the thumbnails 61 displayed in the column-and-row display format. In that case, the user's operations cause the input device 21 to supply an input signal to the selection section 31. In turn, the selection section 31 takes the thumbnails 61 from the folder designated by the user for the single-column display format, and selects the retrieved thumbnails 61 for display in the column-and-row display format in tabular form on each page.

From the selected thumbnails 61, the selection section 31 then chooses a predetermined number of thumbnails 61 for tabular display in a predetermined sequence on each page. For example, the selection section 31 may select 12 thumbnails in a predetermined sequence and establish the selected thumbnails 61 for display in tabular form on a single page. Where thumbnails 61 are arrayed sequentially as shown in FIG. 2, the predetermined number of thumbnails 61 are selected in the predetermined number of consecutive rows for display in tabular form on each page.

In step S12, the background rendering section 32 controls the display device 24 to display a background image against which each page is to be displayed on the device 24.

Illustratively, the user might give an instruction to designate a folder and to display the thumbnails from the designated folder for tabular display in the column-and-row display format. If that is the case, the background rendering section 32 of the display control device 23 causes the display device 24 to render a background image against which page 1 is to be displayed, with the cursor positioned to the first thumbnail.

More specifically, the background rendering section 32 instructs the display device 24 to render the background image of FIG. 2 including the cursor 63 and box frames in which to display each thumbnail 61, i.e., those screen portions inside the frame 62 other than the thumbnails 61-1 through 61-12 and parts of the thumbnails 61-13 through 61-16. Under control of the background rendering section 32, the display device 24 renders the background image and displays it on the display screen. At this point, the background rendering section 32 controls the rendering of the cursor 63 in such a manner that the cursor 63 is positioned to the first thumbnail 61-1 among the thumbnails 61 being arrayed.

The user might operate the input device 21 to issue an instruction to switch from the single-column display format in which the thumbnails 61 are displayed in tabular form on the current page enclosed by the frame 101 as shown in FIG. 4, to another display format (i.e., to the column-and-row display format for tabular display of thumbnails 61). In that case, the display control device 23 proceeds to display a new page of thumbnails 61 to be displayed in the column-and-row display format, including the thumbnail 61 currently selected by the cursor 102 in the single-column display format. On the new page, the background rendering section 32 causes the display device 24 to render the background image in such a manner that the cursor 63 is positioned to the same thumbnail 61 that was selected by the cursor 102 in the single-column display format.

For example, inside the tabular display of thumbnails 61 in the single-column display format in FIG. 4, the cursor 102 is positioned to the thumbnail 61-21. In this case, the display control device 23 causes the display device 24 to display page 2 including the cursor-selected thumbnail 61-21 along with the thumbnails in the column-and-row display format enclosed by the frame 71 in FIG. 3.

The background rendering section 32 instructs the display device 24 to render the background image, i.e., those screen portions within the frame 71 other than the thumbnails 61-13 through 61-24, parts of the thumbnails 61-9 through 61-12, and parts of the thumbnails 61-25 through 61-27. Under control of the background rendering section 32, the display device 24 renders the background image and displays it on the display screen. At this point, the background rendering section 32 controls the rendering of the cursor 63 in such a manner that the cursor 63 in the column-and-row display format is positioned to the thumbnail 61-21 that was shown selected by the cursor 102 among the thumbnails 61 displayed earlier in the single-column display format.

The background image may be rendered successively starting from a predetermined position. Alternatively, the background image may be rendered in portions in order of priority.

If the rendering of the background image is to be started from a predetermined position (i.e., from a predetermined image) in FIG. 3, then the cursor 63 might be rendered first, followed by one box frame after another in which the thumbnails 61-13 through 61-24 are to appear successively.

If the rendering of the background image is to be started from the portion of utmost priority followed by portions of progressively lower priorities in FIG. 3, then the cursor 63 may be rendered first, followed by the box frames closest to the cursor 63 among the box frames in which thumbnails 61 to display. More specifically, the cursor 63 is first rendered, followed by the box frame for accommodating the thumbnail 61-21 to which the cursor 63 is being positioned. Thereafter, the box frames in which to display the thumbnails 61-17, 61-18 and 61-22 are rendered, followed by the box frames for accommodating the thumbnails 61-13 through 61-16, 61-19, 61-20, 61-23, and 62-24, in that order.

As described, the background image may be rendered successively in portions in order of priority. For example, the cursor 63 supposedly attracting most of the user's attention may be first rendered, followed by the box frame in which to display the thumbnail 61 selected by the cursor 63 and by the box frames located nearby. This manner of rendering the background image offers the advantage of displaying the background in portions in order of priority from the user's point of view.

Returning to the flowchart of FIG. 5, step S13 is reached after the background image has been rendered as described above. In step S13, the thumbnail rendering section 33 controls the display device 24 to render thumbnails starting from the one to which the cursor is being positioned. That is, the thumbnail rendering section 33 renders the thumbnails to be displayed in tabular form starting from the thumbnail that is closest to the cursor position. Under control of the thumbnail rendering section 33, the d splay device 24 renders the thumbnails as described and displays them one after another.

For example, when the page (along with its thumbnails) enclosed by the frame 71 in FIG. 3 is to be displayed, the thumbnail rendering section 33 first causes the thumbnail 61-21 selected by the cursor 63 to be rendered. The thumbnail rendering section 33 then renders the thumbnails 61-17, 61-18 and 61-22, followed by the thumbnails 61-13 through 61-16, 61-19, 61-20, 61-23 and 61-24, in that order.

When the thumbnails 61 are rendered starting from the one closest to the position of the cursor 63, the thumbnails 61 are displayed in order of priority as perceived supposedly by the user. This makes it possible to minimize the stress and frustration felt by the user waiting for the desired thumbnails 61 to appear even over a prolonged time period.

Generally, when looking at thumbnails being displayed, the user tends to view the cursor-focused thumbnail first and then those close to it successively. The above method for rendering the thumbnails starting from the cursor-selected one followed by those nearby consecutively allows the user to view the thumbnails in the sequence that is supposedly to his or her taste. The user need not suffer a long wait before his or her preferred thumbnails 61 are displayed.

When the rendering of thumbnails is started, step S14 is reached. In step S14, the background rendering section 32 checks to determine whether or not the cursor is to be moved. Illustratively, the user may operate the input device 21 to give an instruction to move the cursor 63, with the input device 2: supplying the display control device 23 with an input signal reflecting the user's operations. If that is the case, then the background rendering section 32 determines that the cursor 63 is to be moved.

If in step S14 the background rendering section 32 determines that the cursor 63 is not to be moved, then steps S15 and S16 are skipped. Control is then passed on to step S17.

If in step S14 the background rendering section 32 determines that the cursor 63 is to be moved, step S15 is reached. In step S15, the background rendering section 32 checks to determine whether an instruction is given to move the cursor 63 out of the current display screen, i.e., to the preceding or the following page.

For example, suppose that with the thumbnails 61 rendered and displayed in tabular form on the display device 24 enclosed by the frame 71 as shown in FIG. 3, the user operates the input device 21 to issue an instruction to move the cursor 63 downward from the position of the thumbnail 61-21 to the thumbnail 61-25. In that case, the background rendering section 32 determines that the cursor 63 is to be moved out of the display screen. It might also happen that with the thumbnail 61-13 selected by the cursor 63, the user operates the input device 21 to give an instruction to move the cursor 63 up to the thumbnail 61-9. In this case, too, the background rendering section 32 determines that the cursor 63 is to be moved outside the display screen.

If in step S15 the background rendering section 32 determines that the cursor 63 is to be moved out of the display screen, then control is returned to step S12 and the new page that the cursor 63 was moved into starts being rendered. Illustratively, with the thumbnails rendered by the display device 24 in the frame 71 as shown in FIG. 3, the user may operate the input device 21 to issue an instruction to move the cursor 63 from the thumbnail 61-21 to the thumbnail 61-25. In that case, the display control device 23 positions the cursor 63 to the thumbnail 61-25 and makes the thumbnails 61 of page 3 displayed in tabular form. That is, the display control device 23 causes the thumbnails 61-25 through 61-27 to be displayed in tabular form.

If in step S15 it is determined that the cursor 63 is not to be moved out of the display screen, then the background rendering section 32 controls the display device 24 to move the cursor 63 in keeping with the input signal coming from the input device 21, and step S16 is reached. For example, if the thumbnails are displayed within the frame 71 on the display device 24 as shown in FIG. 3, then the background control section 32 controls the display device 24 to move the cursor 63 from the thumbnail 61-21 to the thumbnail 61-22 in accordance with the input signal supplied by the input device 21.

In step S16, the thumbnail rendering section 33 controls the display device 24 to render successively the thumbnails yet to be rendered among those for display in tabular form, starting from the thumbnail that is closest to the one selected by the moved cursor.

Illustratively, it might happen that the rendering of the thumbnails 61 to be displayed in tabular form on the page enclosed by the frame 71 in FIG. 3 is started from the thumbnail 61-21 and that upon completion of rendering of the thumbnail 61-21, the cursor 63 is positioned to the thumbnail 61-22. In such a case, among the thumbnails 61-13 through 61-20 and 61-22 through 61-24 yet to be rendered, the thumbnail rendering section 33 first renders the thumbnail 61-22 selected anew by the cursor 63, then goes on rendering successively the thumbnails nearby such as the thumbnails 61-17, 61-18, 61-19, 61-23, 61-13 through 61-16, 61-20, and 61-24, in that order.

When the cursor 63 is moved as described above, the thumbnail 61 newly selected by the cursor 63 is rendered preferentially, followed by the thumbnails 61 in increasing distance from the selected one, i.e., in order of priority. This makes it possible significantly to reduce the stress and frustration felt by the user waiting for all thumbnails 61 to be rendered.

Step S17 is reached in one of two cases: if in step S16 the thumbnails are rendered starting from those close to the thumbnail selected anew by the moved cursor; or if in step S14 it is determined that the cursor 63 is not to be moved. In step S17, the display control device 23 checks to determine whether or not the rendering of the thumbnails for display in tabular form is to be terminated.

The display control device 23 determines in step S17 that the rendering process is to be terminated in one of two cases: if the user illustratively operates the input device 21 to give an instruction to reproduce the image (still image or moving image) represented by the cursor-selected thumbnail; or if the user operating the input device 21 issues an instruction to switch to the single-column display format in which the thumbnails are rearranged for display in tabular form.

If in step S17 the rendering is found set to be terminated, then step S18 is reached. In step S18, the display apparatus 11 carries out appropriate processing in keeping with the user's operations and terminates the tabular display process. Illustratively, if the user operates the input device 21 to give an instruction to reproduce the image represented by the thumbnail 61-21 selected by the cursor 63 in FIG. 3, then the display control device 23 acquires from the recording device 22 the image of which the reproduction has been designated in accordance with the input signal supplied by the input device 21 reflecting the user's operations. The acquired image is forwarded to the display device 24 whereby the target image is displayed.

As another example, if the user operates the input device 21 to issue an instruction to switch to the single-column display format in which to display the thumbnails in tabular form, then the display control device 23 instructs the components of the display apparatus 11 to start their processes for displaying the thumbnails in the single-column display format in accordance with the input signal supplied by the input device 21 reflecting the user's operations.

If in step S17 it is determined that the processing is not to be terminated, then step S19 is reached. In step S19, the thumbnail rendering section 33 checks to determine whether all target thumbnails for display in tabular form have been rendered. If in step S19 some thumbnails are found yet to be rendered, then step S14 is reached again and the rendering of the thumbnails to be displayed in tabular form is continued.

If in step S19 all target thumbnails are found to have been rendered, then step S20 is reached. In step S20, the thumbnail rendering section 33 controls the display device 24 to render the parts of thumbnails included in the current page. For example, if the page enclosed by the frame 71 in FIG. 3 is being displayed on the display device 24, then the thumbnail rendering section 33 controls the display device 24 to render parts of the thumbnails 61-9 through 61-2 and parts of the thumbnails 61-25 through 61-27.

In step S21, the display control device 23 checks to determine whether the process for displaying the thumbnails in tabular form is to be terminated.

Illustratively, the user may operate the input device 21 to give an instruction to reproduce the image represented by the cursor-selected thumbnail or an instruction to switch to the single-column display format in which to display the thumbnails in tabular form. In such a case, the display control device 23 determines that the process is to be terminated.

If in step S21 it is determined that the process is to be terminated, then control is passed on to step S18. In step S18, suitable processing is carried out in keeping with the user's operations and the tabular display process is terminated.

If in step S21 it is determined that the process is not to be terminated, then step S22 is reached. In step S22, the display control device 23 performs suitable processing in accordance with the user's operations. For example, the user may operate the input device 21 to designate a movement of the cursor 63 shown in FIG. 3. In that case, the background rendering section 32 of the display control device 23 causes the display device 24 to render the cursor 63 in the destination of the movement designated by the input signal coming from the input device 21 reflecting the user's operations.

In step S23, the display control device 23 checks to determine whether the cursor is moved out of the display screen, i.e., whether an instruction is given to move the cursor from the currently displayed page to the preceding or the next page.

Illustratively, it might happen that with the thumbnails 61 displayed within the frame 71 on the display screen of the display device 24 as shown in FIG. 3, the user operates the input device 21 to issue an instruction to move the cursor from the thumbnail 61-21 to the thumbnail 61-25. In that case, the display control device 23 determines that the cursor 63 is moved out of the display screen.

If in step S23 the cursor is found to be moved out of the display screen, then control is returned to step S12. In step S12, the thumbnails in the new page to which the cursor has been moved are rendered for display in tabular form.

If in step S23 the cursor is not found to be moved outside the display screen, then control is returned to step S21, and the subsequent steps are repeated.

As described, the display apparatus 11 displays thumbnails in tabular form by rendering the background image, the thumbnails, and parts of thumbnails. When displaying on the current page those parts of the thumbnails which belong to the preceding or the next page, the display apparatus 11 allows the user to recognize easily and reliably whether the current page is preceded and/or followed by more pages of thumbnails in a multiple-page tabular display arrangement.

When displaying thumbnails in tabular form over a plurality of pages, ordinary systems capable of grasping all the pages may indicate the total page count and the current page number, i.e., the position of the currently displayed page in the sequence of all pages. Such systems may also display scroll bars indicating which portion of all thumbnails is currently displayed. If the system cannot grasp in advance the total number of pages containing thumbnails, then the system is incapable of letting the user know which page is being displayed or whether there is any page preceding or following the current page.

However, even if a system cannot grasp beforehand the total number of thumbnail-carrying pages, that system may be arranged to display, as shown in FIG. 3, parts of the thumbnails belonging to the page preceding and/or following the currently displayed page. Actually viewing parts of the thumbnails 61 displayed in tabular form from the preceding and/or the following page allows the user intuitively to recognize that the current page is preceded and/or followed by more pages.

When the user operates the input device 21 to move the cursor 63 to any part of the thumbnails 61 on the preceding or following page, the user's operation is interpreted as one for page feed. That is, simply moving the cursor 63 out of the current page to another page enables the user to call up the preceding or the following page.

In the foregoing description, the thumbnails for display in tabular form were shown to be rendered successively, first the cursor-selected thumbnail followed by those in increasing distance therefrom. Alternatively, the thumbnails targeted for display in tabular form may be prioritized as desired and then rendered in order of priority.

For example, when the page enclosed by the frame 71 in FIG. 3 is to be displayed, the thumbnails 61 may be rendered in the order in which they have been arrayed in ascending order of their reference numerals, i.e., from the thumbnail 61-13 through the thumbnail 61-24. Alternatively, the columns and the rows of thumbnails 61 may be prioritized in descending order from left to right and from top to bottom, respectively, preparatory to rendering. Specifically, the thumbnails 61-13, 61-17, 61-21, and 61-14 may be rendered in that order.

As another alternative, in FIG. 3, the thumbnails 61 in the row (i.e., in the horizontal direction) that contains the thumbnail selected by the cursor 63 may be given priority, or the thumbnails 61 in the column (i.e., in the vertical direction) that includes the cursor-selected thumbnail may be given precedence preparatory to rendering.

As a further alternative, the display control device 23 may record a history of cursor movements that were effected to select thumbnails. On the basis of that history, the thumbnail rendering section 33 may determine the sequence in which to render the thumbnails.

Illustratively, suppose that in FIG. 3 the cursor 63 is moved to select the thumbnails 61-9 through 61-12, in that order and that the page enclosed by the frame 71 is displayed after the cursor 63 is moved from the thumbnail 61-12 to the thumbnail 61-13. In such a case, the thumbnail to which the cursor 63 is expected to be positioned next is the thumbnail 61-14, followed with high probability by the thumbnails 61-15 through 61-24. The thumbnail rendering section 33 then renders the thumbnails 61-13 through 61-24, in that order.

Suppose also that the cursor 63 is moved to select the thumbnails 61-1, 61-5 and 61-9, in that order and that the cursor 63 is then positioned to the thumbnail 61-13 so as to call up the page enclosed by the frame 71. In this case, the thumbnail to which the cursor 63 is expected to be positioned next is the thumbnail 61-17, followed with high probability by the thumbnail 61-21. Then the thumbnail rendering section 33 renders the thumbnails 61-13, 61-17, 61-21, 61-14, 61-18, 61-22, 61-15, 61-19, 61-23, 61-16, 61-20 and 61-24, in that order.

If the user operates the input device 21 to designate a given folder and to specify that the thumbnails stored in the designated folder be displayed in the single-column display format, or if, with thumbnails displayed in the column-and-row display format, the user designates switchover to the single-column display format, then the display apparatus 11 may get the thumbnails displayed in the single-column display format by carrying out steps similar to those constituting the tabular display process for display in the column-and-row display format discussed above in reference to the flowchart of FIG. 5.

In the above case, the step corresponding illustratively to step S11 in FIG. 5 involves the selection section 31 selecting a predetermined number of thumbnails 61 per page for tabular display in a single column as shown in FIG. 4, the thumbnails being arrayed continuously downward in a predetermined order.

Thereafter, steps similar to steps S12 through S23 are carried out so that the background image including the cursor 102, the thumbnails 61, and parts of thumbnails 61 are rendered successively.

In the foregoing description, it was shown that in the column-and-row display format as well as in the single-column display format, thumbnails are displayed in tabular form in increments of pages, i.e., in batches on a plurality of pages. Alternatively, thumbnails may be displayed in increments of pages when displayed either in the column-and-row display format or in the single-column display format, and may be scrolled in tabular form when displayed in the other format.

For example, it might happen that thumbnails are set to be scrolled for tabular display in the single-column display format illustratively as shown in FIG. 4, with the thumbnails displayed on the display device 24 enclosed by the frame 101. In that case, the user may operate the input device 21 to scroll up and down the thumbnails 61 displayed in tabular form on the screen of the display device 24.

The series of the steps or processes described above may be executed either by hardware or by software. For the software-based processing to take place, the programs constituting the software may be either incorporated beforehand in dedicated hardware of a computer for program execution or installed upon use from a suitable program recording medium into a general-purpose personal computer or like equipment capable of executing diverse functions based on the installed programs.

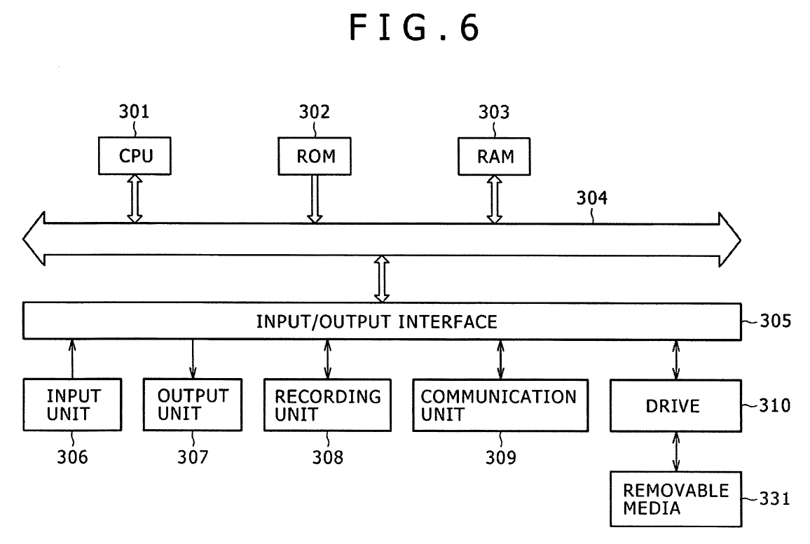

FIG. 6 is a block diagram showing a typical structure of a personal computer for carrying out the above-described steps using programs. A CPU (central processing unit) 301 performs various processes in accordance with the programs stored in a ROM (read only memory) 302 or on a recording unit 308. A RAM (random access memory) 303 accommodates the programs or data to be executed or operated on respectively by the CPU 301 as needed. The CPU 301, ROM 302, and RAM 303 are interconnected by a bus 304.

An input/output interface 305 is connected to the CPU 301 by way of the bus 304. The input/output interface 305 is connected with an input unit 306 and an output unit 307. The input unit 306 is typically made up of a keyboard, a mouse and a microphone. The output unit 307 may be composed of a display and speakers. The CPU 301 carries out diverse processes in response to commands that are input from the input unit 306. The result of the processing is forwarded from the CPU 301 to the output unit 307.

The recording unit 308 connected to the input/output interface 305 is typically constituted by a hard disk drive and records the programs and data to be executed and operated on by the CPU 301. A communication unit 309 communicates with external apparatuses through networks such as the Internet and local area networks.

Programs may be acquired through the communication unit 309 and may be recorded to the recording unit 308.

A drive 310 connected to the input/output interface 305 accommodates removable media 331 such as a magnetic disk, an optical disk, a magneto-optical disk or a semiconductor memory. When loaded with one such removable medium 331, the drive 310 acquires programs and/or data that may be stored on the medium. The acquired programs and data are transferred as needed to the recording unit 308 for storage.

As shown in FIG. 6, the program recording media for accommodating computer-installable, computer-executable programs designed to perform the above-described processes are constituted not only by such package media as magnetic disks (including flexible disks), optical disks (including CD-ROM (compact disc read-only memory) and DVD (digital versatile disc)), magneto-optical disks, or semiconductor memory; but also by the ROM 302 and recording unit 308 (e.g., hard disk) which may have the programs stored thereon temporarily or permanently. The programs are recorded to the recording media via the communication unit 309 such as a router and a modem acting as an interface and through wired or wireless communication media such as local area networks, the Internet, and digital satellite broadcasting networks.

In this specification, the steps describing the programs stored on the program recording medium represent not only the processes that are to be carried out in the depicted sequence (i.e., on a time series basis) but also processes that may be performed parallelly or individually and not chronologically.

It should be understood by those skilled in the art that various modifications, combinations, sub-combinations and alterations may occur depending on design requirements and other factor in so far as they are within the scope of the appended claims or the equivalents thereof.

What is claimed is:

1. A display control apparatus for providing a tabular display of a plurality of images divided into a plurality of continuous pages, said display control apparatus comprising:
selection means for selecting from said plurality of images the images to be displayed on each of said plurality of pages; and
display control means for controlling the display of said plurality of images in such a manner that the images selected by said selection means are displayed in tabular form on a given page along with parts of the images included in at least either the preceding or the following page continuous to said given page.

2. The display control apparatus according to claim 1, wherein said display control means causes the selected images for display in tabular form on said given page to be arranged in a first direction as well as in a second direction different from said first direction, said parts of the included images being arrayed in a manner parallel with said first direction and continuous to said given page in said second direction.

3. The display control apparatus according to claim 1, wherein said display control means further displays a cursor for selecting one of the images for display in tabular form on said given page, said display control means further renders the images on said given page starting from the image being selected by said cursor.

4. The display control apparatus according to claim 3, wherein, if an instruction is given to move said cursor before the rendering of said images on said given page is completed, then said display control means renders the yet-to-be rendered images successively starting from the image selected anew by the moved cursor.

5. The display control apparatus according to claim 3, wherein, if an instruction is given to display said images on said given page in a first display format different from a second display format in which said images on said given page are currently displayed in tabular form, then said display control means displays said images in said first display format in such a manner that the image selected by said cursor on said given page in said second display format is also selected by said cursor in said first display format.

6. The display control apparatus according to claim 1, wherein said display control means controls the display of said plurality of images in such a manner as to start rendering a portion of said given page other than the selected images for display in tabular form and said parts of the included images on said given page, so that the rendering of said selected images for display in tabular form and of said parts of said included images on said given page is started upon completion of the rendering of said portion.

7. The display control apparatus according to claim 1, wherein said display control means renders successively the selected images for display in tabular form on said given page starting from the image of utmost priority.

8. A display control method for providing a tabular display of a plurality of images divided into a plurality of continuous pages, said display control method comprising the steps of:
selecting from said plurality of images the images to be displayed on each of said plurality of pages; and
controlling the display of said plurality of images in such a manner that the selected images are displayed in tabular form on a given page along with parts of the images included in at least either the preceding or the following page continuous to said given page.

9. A program for causing a computer to carry out a display control process for providing a tabular display of a plurality of images divided into a plurality of continuous pages, said display control process comprising the steps of:
selecting from said plurality of images the images to be displayed on each of said plurality of pages; and
controlling the display of said plurality of images in such a manner that the selected images are displayed in tabular form on a given page along with parts of the images included in at least either the preceding or the following page continuous to said given page.

10. A display control apparatus for providing a tabular display of a plurality of images divided into a plurality of continuous pages, said display control apparatus comprising:
a selection device configured to select from said plurality of images the images to be displayed on each of said plurality of pages; and
a display control device configured to control the display of said plurality of images in such a manner that the images selected by said selection device are displayed in tabular form on a given page along with parts of the images included in at least either the preceding or the following page continuous to said given page.
